(19) United States
(12) Patent Application Publication
(10) Pub. No.: US 2018/0039802 A1
(43) Pub. Date: Feb. 8, 2018

(54) RFID Apparatus for Communicating with RFID Transponders and Method of Associating RFID Transponders

(71) Applicant: SICK AG, Waldkirch (DE)

(72) Inventor: Volker WILLHOEFT, Waldkirch (DE)

(21) Appl. No.: 15/663,167

(22) Filed: Jul. 28, 2017

(30) Foreign Application Priority Data
Aug. 3, 2016 (DE) 102016114316.2

(51) Int. Cl. G06K 7/10; G01S 13/82; G01S 11/02

(52) U.S. Cl. CPC G06K 7/10366; G01S 11/026; G01S 13/82

(57) ABSTRACT

An RFID apparatus for communicating with RFID transponders in accordance with an RFID protocol is provided that has an antenna, an RFID transceiver for emitting and receiving RFID signals with the aid of the antenna and has a control unit that is configured to encode RFID information into an RFID signal in accordance with an RFID protocol or to read said information from the RFID signal and to determine at least one spatial and/or speed parameter of an RFID transponder with reference to the RFID signal. The control unit is further configured to read container transponders and object transponders and to associate an object transponders with a container transponder with reference to the respective spatial and/or speed parameters.

The invention relates to an RFID apparatus for communicating with RFID transponders in accordance with an RFID protocol that has an antenna, an RFID transceiver for emitting and receiving RFID signals with the aid of the antenna and a control unit that is configured to encode RFID information into an RFID signal in accordance with an RFID protocol or to read said information from the RFID signal and to determine at least one spatial and/or speed parameter of an RFID transponder with reference to the RFID signal. The invention further relates to a method of associating RFID transponders, wherein communication with the RFID transponders takes place in accordance with an RFID protocol in that an RFID signal is emitted and received and RFID information is encoded into the RFID signal or is read from the RFID signal in accordance with the RFID protocol, with at least one spatial and/or speed parameter of an RFID transponder being determined with reference to the RFID signal.

RFID systems serve for the identification of objects and goods and are used inter alia to automate logistical movements. RFID transponders fastened to the goods are read at an identification point, above all on a change of the owner of the good or on a change of the transport means, and information is optionally written back to the transponder. This results in fast and traceable logistical movements. The detected information is used to control the forwarding, storage, and sorting of goods and products.

The RFID transponders are excited by electromagnetic radiation of the read/write system for the emission of the stored information, wherein passive transponders obtain the required energy from the transmission energy of the reading system and the less customary active transponders have their own supply for this purpose. Passive transponders are read in accordance with the backscatter method in the established ultrahigh frequency standard EPC Generation 2 UHF RFID, whose air interface is defined in ISO 18000-6.

In many warehouses or logistics centers, the goods are not conveyed individually, but with the aid of transporter containers such as plastic trays or pallets. It is then advantageous if both the goods and the transport containers themselves are provided with RFID transponders. An RFID system can read all the transponders that are located in its detection zone, also through non-conductive material of the transport containers or objects. Objectives such as the compilation of a goods delivery from individual goods and their inspection for completeness can thus now be achieved or goods are located on a pallet that should now be specifically associated with this pallet.

An association of a plurality of transponders with one another is to date only possible if the corresponding transponders are located in the detection zone of an RFID apparatus. A conventional solution is the separation of goods, for instance in an RFID reading tunnel having a conveyor belt on which containers are conveyed separately. Only one single container is then always located in the detection zone. As soon as further goods or transport containers having RFID transponders are located in the detection zone, for example due an overreach of the RFID apparatus, false associations can occur. There are algorithmic approaches such as an SAR (successive approximation register) process, but they are complex and not established.

DE 10 2010 020 531 A1 discloses an RFID reading apparatus for installation at a conveyor or at reading portal having an antenna whose reception range pivots along with the movement of the transponders. A decision is then made with reference to the reception intensity whether a transponder moves on the conveyor or through the reading portal. This RFID reading apparatus is relatively sluggish due to the pivoting-along antenna and is only usable or special applications having paths known in advance. DE 10 2010 020 531 A1 also relies on a separation of the objects for a specific association with an object.

It is therefore an object of the invention to enable a more reliable association of transponders.

This object is satisfied by an RFID apparatus for communicating with RFID transponders and by a method for associating RFID transponders in accordance with the respective independent claim. The RFID apparatus is also called an interrogator, an RFID reader or an RFID read/write apparatus, since an RFID apparatus is also typically able to write. The RFID apparatus is preferably configured for the UHF range in accordance with ISO 18000-6. In addition to the actual communication using an RFID transponder, for instance by read and write commands in accordance with an RFID protocol such as ISO 18000-6, the RFID apparatus is also able to determine a spatial parameter or a speed parameter of the RFID transponder from the RFID signal.

The invention now stars from the basic idea of utilizing positional or movement information from container transponders and object transponders for an association. In this respect, a container transponder is arranged at a container such as a box, a pallet or also an AGV (automated guided vehicle) a fork lift or another transport means and an object transponder is arranged at an object that can be located in this container. Container transponders such as object transponders are RFID transponders in accordance with the RFID protocol. They can be completely similar to one another per se and can only differ as to whether they are arranged at the container or at the object. Information is preferably stored on the respective transponder from which it can be deduced whether it is a container transponder or an object transponder. The aim of the association is to determine which objects identified by object transponders are located at or in the container identified by container transponders. This association can only associate an object to a container; it is generally an association of m objects to m containers.

The invention has the advantage that a reliable m to n association is also possible for a large number of transponders in the detection zone of the RFID reading apparatus. Specific criteria for the association can be selected in the application. A separation of objects or containers is no longer necessary. The efficiency of logistics systems can thereby be increased by a faster clock rate of the containers and a cost advantage results because separation systems are dispensed with. In addition error states can be recognized, for example a dormant transponder. The spatial and speed parameters are also useful to recognize a direction of movement, for instance whether the transponder moves into a warehouse or out of a warehouse or to avoid multiple counts.

The control unit is preferably configured to determine the angle at which an RFID transponder is detected as the spatial parameter. This angle which corresponds to the detection direction (direction of arrival, DOA) already includes essential information on the position of transponders and can be reliably determined by the RFID apparatus. One option is a phase process having more than one antenna. The angle information can additionally be linked to prior knowledge, for example that transponders move on a conveyor or on a specific track so that the positional information is completed.

The control unit is preferably configured to determine the spacing at which an RFID transponder is detected as the spatial parameter. One possibility of measuring this is the level (received signal strength indicator, RSSI) of the RFID signal. However, the RSSI also varies with the orientation of the transponder and with the material between the transponder and the RFID apparatus. However, delimitable spatial information in particular results in combination with the determination of the angle. A phase process can also measure the spacing, however, still with ambiguity with respect to the wavelength of the carrier frequency, with this ambiguity in turn being able to be resolved by using two frequencies.

The control unit is preferably configured to associate all object transponders at a maximum spacing with one container transponder as a center. The container transponder is, for example, arranged at the center of a container and the maximum spacing corresponds to half the container dimensions. Different maximum spacings in the width direction, length direction and/or vertical direction are also conceivable. It is then advantageous if information is present on the orientation of the containers, for example because boxes are always stacked in a specific manner or are disposed over a conveyor belt or because the direction of travel of a vehicle can be determined. A typical parallelepiped shape or another geometrical shape of the container can thus also be taken into account.

The control unit is preferably configured to associate all the object transponders having a similar speed with one container. A speed parameter can be detected as the difference of two spatial parameters and the time interval between their determination, but also directly, for example by the Doppler effect. An affiliated group of transponders should move at the same speed except for tolerances. The use of a speed determination can differ greatly from application to application. Transponders on individually moved transport vehicles form clear speed clusters; with objects on a conveyor, in contrast, practically all the definition is lacking. A check can additionally be made whether the transponders having a similar speed among themselves are disposed closer together. An equal sped is more a matter of chance from a specific maximum spacing onward, particularly when there are even further transponders having different speeds between two transponders of similar speeds. As with a location-based association criterion, the speed in one, two or three axes can be compared.

The control unit is preferably configured to draw an outer boundary with reference to at least two container transponders and to associate all the object transponders arranged therebetween with the container transponders. The position of the container transponder in this respect does not necessarily have to define the border point, but there can rather be an offset. An example for this association criterion is a respective container transponder at the front and at the rear at a box. More complex, also two-dimensional or three-dimensional, border lines can be drawn using further container transponders. This association criterion is also preferably combined with others. In the example, all the object transponders then belong to the container that are located between the container transponders fastened to the front and rear at the box and that additionally remain within a respective maximum spacing in the depth and height direction or that additionally move at almost the same speed with respect to one another and with respect to the container transponders.

The control unit is preferably configured to associate container transponders among one another by a comparison of spatial and/or speed parameters. Not only object transponders are therefore associated with the container transponders. In addition, the container transponders are also associated with one another in accordance with the analog criteria to determine whether they identify the same container. It will frequently be simpler and more reliable to write this affiliation to one another and to a container to the container transponder. Unlike the object transponders that typically change container and are thereby separated from one another, container transponders of the same container remain with one another in accordance with their intended purpose, at least for a longer time, so that an initialization with such affiliation information is possible and sensible. It is also conceivable to associate the container transponders with one another with reference to spatial and speed parameters even though the affiliation is already known due to their RFID information. Indications are namely thereby obtained on how the spatial and speed parameters of affiliated transponders behave in the specific measurement situation and this can be taken into account in the association of object transponders, for example to check an association or to set tolerances.

The control unit is preferably configured to determine spatial and/or speed parameters at at least two points in time and to support the association thereon. The association is then not based on a single instantaneous picture, but rather on at least one repeat. A particularly stable association is acquired by numerous repeats and corresponding optimizing cluster algorithms on time-dependent spatial and/or speed information such as are known from 3D navigation or from object tracking. The speed can also be determined very exactly from a repeated spatial determination and can be used as a cluster criterion in addition to the trajectories.

The control unit is preferably configured to take account of a compulsory guidance of the RFID transponders during the determination of the spatial and/or speed parameters and during the association. Examples of a compulsory guidance include a conveyor belt or a fixed track for vehicles carrying container transponders. The determination of spatial and speed parameters and the association based thereon can then be restricted to the degrees of freedom the compulsory guidance still allows.

The control unit is preferably configured to recognize when a changed association occurs on a repeated association of object transponder to container transponder. For example, if an object transponder is now associated with a different container transponder it is no longer able to be associated or is even no longer locatable at all. This indicates an error condition. The association was either subject to an error or an object actually did fall down in the physical world or was removed from its container in a manner not provided for. Before error measures are taken, the new association should preferably automatically be compared with intended measures of the respective system.

The method in accordance with the invention can be further developed in a similar manner and shows similar advantages in so doing. Such advantageous features are described in an exemplary, but not exclusive, manner in the subordinate claims dependent on the independent claims.

The invention will be explained in more detail in the following also with respect to further features and advantages by way of example with reference to embodiments and to the enclosed drawing. The Figures of the drawing show in:

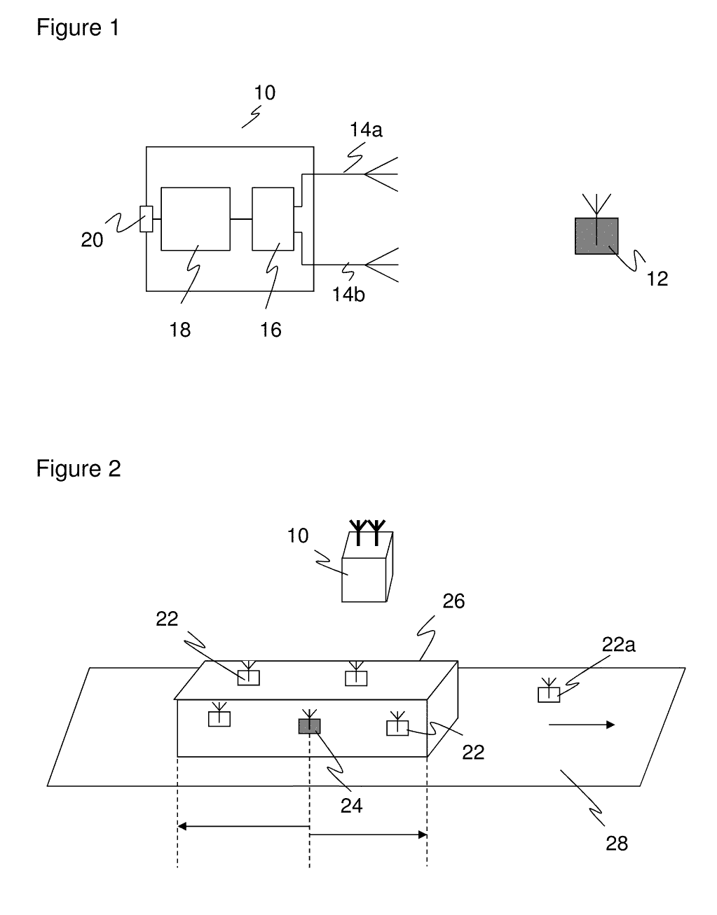

FIG. 1 a simplified block diagram of an RFID apparatus with an RFID transponder in its display;

FIG. 2 an example of an association of object transponders with a container transponder that is located at the center of a box;

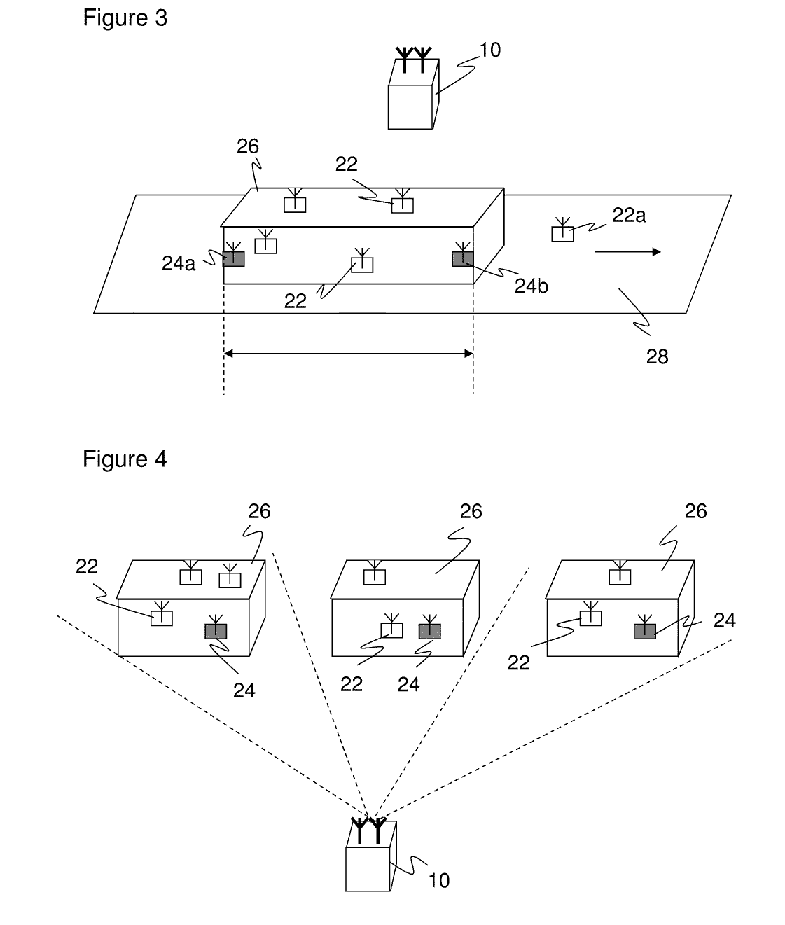

FIG. 3 an example of an association of object transponders with container transponders that mark the front and rear ends of a box; and

FIG. 4 an example of an association of object transponders to container transponders based on the reading angle.

FIG. 1 shows a schematic overview representation of an RFID apparatus 10 and of an RFID transponder 12 arranged in an exemplary manner in its reading range. The RFID apparatus 10 in this embodiment has two antennas 14a-b to be able to carry out a localization of the RFID transponders 12 over phase measurements of the incoming waves. In alternative embodiments, there is only one antenna or, conversely, there are further antennas.

The RFID apparatus 10 transmits and receives RFID signals via the antennas 14a-b with the aid of a transceiver 16. A control unit 18, for example having a digital module such as a microprocessor or an FPGA (field programmable gate array) controls the routines in the RFID apparatus 10 and is able to encode RFID information into an RFID signal or to read RFID information from an RFID signal. A wired or wireless connector 20 serves to integrate the RFID apparatus 10 into a higher ranking system.

The communication preferably takes place in accordance with a known RFID protocol, in particular ISO 18000-6 or EPC Generation 2 UHF RFID and the steps and components required for this are known per se and are considered as known in the same way as the exact design of the RFID apparatus 10 going beyond the rough functional blocks of FIG. 1.

The RFID apparatus 10 is also able to detect spatial or speed information of the RFID transponder 12 in addition to the detection and optionally change of the actual RFID information stored on the RFID transponder 12 such as its identification. Properties of the carrier wave itself are evaluated for this purpose, that is the RFID signal, and not the RFID information stored on the RFID transponder 12 and encoded into the RFID signal.

In the embodiment of FIG. 1, the different phase at the two antennas 14a-b is evaluated. The angle at which the RFID transponder 12 was read can first be thereby determined and a spatial association of the tags can be carried out at least angle-wise. It is also conceivable to determine the spacing of the RFID transponder 12 from the phase information. This ambiguously remains module λ, but the carrier wavelength can nevertheless deliver useful information. In addition, the non-ambiguity range can also be expanded, for example by measuring using two frequencies. Further possibilities of detecting spatial or speed information include evaluations of the level (RSSI) or measurements of the Doppler effect. The detection of spatial or speed information by an RFID apparatus 10 is known per se and will therefore not be described more exactly; the RFID apparatus 10 in accordance with the invention only utilizes such information.

It is also conceivable to acquire additional spatial or speed information by further sensors such as a camera or a laser scanner, to obtain them as parameters such as the conveying speed of a conveyor belt on which RFID transponders 12 are located or to obtain such information from another system such as the control of a vehicle or other transport means conveying RFID transponders 12.

The spatial and speed information are now used by the control unit 18 to associate RFID transponders 12 with one another. In this respect, the control unit 18 can also be implemented wholly or partly outside the RFID apparatus 10. This is illustrated for a plurality of examples with respect to FIGS. 2 to 4.

FIG. 2 shows an example of an association of object transponders 22 with a container transponder 24. The object transponders 22 and container transponders 24 are each RFID transponders, but the control unit 18 is also able to recognize container transponders 24 as such with reference to the identification or to any other information that it has itself or reads by RFID. The container transponder 24 identifies a container 26 on a conveyor belt 28 in which objects, not themselves shown, with object transponders 22 are located. The conveyor belt 28 is only one application example; they can alternatively be any desired containers moved passively or actively or also not moved.

The association objective now comprises associating the object transponders 22 in the container 26 to its container transponder 24. An object transponder 22a outside the container 26, that is likewise located in the reading range, should in contrast not be associated with the container transponder 24. For this purpose, the container transponder 24 is attached centrally in the container 26. In addition, the control unit 18 is aware, optionally by reading the container transponder 24, of how long the container 26 is in the conveying direction. All the object transponders 22 that are located at a maximum at the spacing of half the container length from the container transponder 24 are now consider as affiliated in the container 26 and thus with the container transponder 24. It is sufficient for this distinction to know the reading angle and to determine an angular range for the container 26 with reference to the container dimensions and to the reading angle of the container transponder 24. Different or more exact spatial information is, however, equally conceivable. It is also conceivable to check the angle in the vertical direction fully analogously with reference to the height of the container 26. If the position of the transponders 22, 24 in the depth direction is also known, for instance by phase measurement or RSSI measurement, the depth of the container 26 can also fully correspondingly be checked.

FIG. 3 shows a further example of an association of object transponders 22 with a container transponder 24. Unlike FIG. 2, two container transponders 24a-b are here located at the front and rear at the container 26 in the conveying direction. Precisely those object transponders 22 that are disposed between the container transponders 24a-b are associated with the container transponders 24a-b and thus with the container 26. The remaining statements on FIG. 2 apply accordingly. It is conceivable to provide further container transponders to define the boundary line within which the object transponders 22 to be associated are disposed more precisely and in further degrees of freedom than only the conveying direction. This is above all useful when the container 26 is not located on a conveyor belt 28 or when there are a plurality of conveyor belts in relatively close adjacency next to one another or above one another.

FIG. 4 shows a further example of an association of object transponders 22 with container transponders 24. It is here, for example, a question of goods stacks on pallets. It can directly be seen that a separation and association with the left, middle and right pallets is possible with reference to the reading angle. If the reading angle is also detected in the vertical direction, pallets can also be distinguished in stacked form.

It generally applies that the association can be the more complex, the better the spatial and speed information is. On a 3D localization of transponders, containers standing behind one another can, for example, also be correctly processed or even nested arrangements in which a plurality of transport containers full of goods stand on a pallet. In this case, a kind of high-ranking meta-container transponder can be present and the association problem becomes a 1 to m to n problem or an even more using nested problem that, however, remains solvable completely analogously with correspondingly good spatial and speed information.

The association also allows an error recognition if it changes over the course of time. For example, an object with an object transponder 22 that does not move in conformity with its container 26 is no longer in the container 26 or has fallen down.

A movement of the containers 26 and objects during the detection is not required. However, it does have advantages since a multiple detection and association becomes possible. In addition to statistical improvements, the transponders 22, 24 are thereby observed from different positions so that the risk of an unread transponder 22, 24 that is only weakly reached in an instantaneous position falls considerably. All the transponders 22, 24 are furthermore seen from different angles. Particularly with large containers 26 such as a pallet and with object transponders 22 at their margins, this distinction improves whether the object transponder 22 is still located at the outer margin of the one container 26 or already that of the adjacent container 26.

1. An RFID apparatus for communicating with RFID transponders in accordance with an RFID protocol, the RFID apparatus comprises:
an antenna,
an RFID transceiver for emitting and receiving RFID signals with the aid of the antenna, and
a control unit that is configured to encode RFID information into an RFID signal in accordance with an RFID protocol or to read said information from the RFID signal and to determine at least one spatial and/or speed parameter of an RFID transponder with reference to the RFID signal,
wherein the control unit is further configured to read container transponders and object transponders and to associate an object transponder with a container transponder with reference to the respective spatial and/or speed parameters.

2. The RFID apparatus in accordance with claim 1,
wherein the control unit is configured to determine the angle at which an RFID transponder is detected as the spatial parameter.

3. The RFID apparatus in accordance with claim 1,
wherein the control unit is configured to determine the spacing at which an RFID transponder is detected as the spatial parameter.

4. The RFID apparatus in accordance with claim 1,
wherein the control unit is configured to associate all the object transponders at a maximum spacing with a container transponder as the center.

5. The RFID apparatus in accordance with claim 1,
wherein the control unit is configured to associate all the object transponders having a similar speed with one container transponder.

6. The RFID apparatus in accordance with claim 1,
wherein the control unit is configured to draw an outer border with reference to at least two container transponders and to associate all the object transponders arranged therebetween with the container transponders.

7. The RFID apparatus in accordance with claim 1,
wherein the control unit is configured to associate container transponders with one another by a comparison of spatial and/or speed parameters.

8. The RFID apparatus in accordance with claim 1,
wherein the control unit is configured to determine spatial and/or speed parameters at at least two points in time and to support the association thereon.

9. The RFID apparatus in accordance with claim 1,
wherein the control unit is configured to recognize when a changed association occurs on a repeated association of object transponder to container transponder.

10. The RFID apparatus in accordance with claim 1,
wherein the control unit is configured to take account of a compulsory guidance of the RFID transponders during the determination of the spatial and/or speed parameters and during the association.

11. A method of associating RFID transponders, wherein communication with the RFID transponders takes place in accordance with an RFID protocol in that an RFID signal is emitted and received and RFID information is encoded into the RFID signal or is read from the RFID signal in accordance with the RFID protocol, with at least one spatial and/or speed parameter of an RFID transponder being determined with reference to the RFID signal, wherein container transponders and object transponders are read out and an object transponder is associated with a container transponder with reference to the respective spatial and/or speed parameters.
